(19) United States
(12) Patent Application Publication
(10) Pub. No.: US 2014/0312165 A1
(43) Pub. Date: Oct. 23, 2014

(54) METHODS, APPARATUS AND SYSTEMS FOR AERIAL ASSESSMENT OF GROUND SURFACES

(71) Applicant: Armen Mkrtchyan, Cambridge, MA (US)

(72) Inventor: Armen Mkrtchyan, Cambridge, MA (US)

(21) Appl. No.: 14/217,387

(22) Filed: Mar. 17, 2014

Related U.S. Application Data
(60) Provisional application No. 61/798,218, filed on Mar. 15, 2013.

(51) Int. Cl. B64D 47/08; B64C 39/02

(52) U.S. Cl. CPC B64D 47/08; B64C 39/02
USPC 244/13

(57) ABSTRACT

A hand-launched unmanned aerial vehicle (UAV) to determine various characteristics of ground surfaces. The UAV includes a lightweight and robust body/wing assembly, and is equipped with multiple consumer-grade digital cameras that are synchronized to acquire high-resolution images in different spectra. In one example, one camera acquires a visible spectrum image of the ground over which the UAV is flown, and another camera is modified to include one or more filters to acquire a similar near-infrared image. A camera mount/holder system facilitates acquisition of high-quality images without impacting the UAV's flight characteristics, as well as easy coupling and decoupling of the cameras to the UAV and safeguarding of the cameras upon landing. An intuitive user interface allows modestly trained individuals to operate the UAV and understand and use collected data, and image processing algorithms derive useful information regarding crop health and/or soil characteristics from the acquired images.

### PRIORITY

The present application claims a priority benefit to U.S. provisional application Ser. No. 61/798,218, filed Mar. 15, 2013, entitled “Methods, Apparatus and Systems for Aerial Assessment of Ground Surfaces,” which application is hereby incorporated by reference herein in its entirety.

### BACKGROUND

Analysis of surface vegetation and soil for agricultural purposes has been conventionally facilitated by satellite imagery, manned aircrafts and in some instances UAVs. Conventional approaches that employ aircrafts often utilize large planes, an expensive and specialized camera system with relatively low resolution, and complicated analysis tools that require extensive training to use properly. The camera systems conventionally used to gather data are expensive, large, and heavy. Moreover, large airplanes and their control mechanisms require not only several trained individuals for safe and successful operations, but also extensive resources, such as fuel, setup costs, time, and most large airplanes require a dedicated landing area (which is often hard to find in agricultural landscapes, less-developed landscapes, or significantly developed and densely built landscapes).

### SUMMARY

Various embodiments of the present invention generally relate to methods, apparatus, and systems for assessing ground surfaces (e.g., in developed or undeveloped landscapes) to determine various characteristics of such surfaces (e.g., vegetation characteristics, including type, density, and various vegetation health metrics; soil characteristics, including water content, presence and amounts of respective nutrients, presence and amounts of other particular substances, etc.; topography of natural or built landscapes, such as density of particular objects, distribution of objects over a particular geographic area, size of objects, etc.; topography and layout of engineered structures such as roads, railways, bridges, and various paved areas; natural or engineered flow patterns of water sources). In various implementations, such assessments typically are facilitated by small UAVs equipped with one or more special-purpose image acquisition devices to obtain images that may be particularly processed to extract relevant information regarding target characteristics to be assessed in connection with ground surfaces.

In one embodiment, a small, hand-launched UAV that flies autonomously over a specified area and gathers data using multiple cameras is employed to assess ground surfaces. The data that is collected by the UAV is later analyzed using specific data analysis algorithms according to other embodiments of the present invention. In some implementations, areas of interest include agricultural tracts for which crop health (e.g., crop density, growth rate, geographic specific crop anomalies, etc.), and/or soil properties and other natural resources, are analyzed to facilitate customized farming and crop-development techniques to improve yield. Furthermore, the UAV can be flown periodically to gather time series information about a farm, which can be used to predict the yield and help pinpoint areas that may be prone to various diseases.

In sum, one embodiment is directed to a hand-launched unmanned aerial vehicle (UAV) comprising: a fuselage; a first wing and a second wing respectively coupled to the fuselage; a first camera coupled to the first wing and positioned so to obtain at least one visible spectrum image of a ground surface over which the UAV is flown; and a second camera coupled to the second wing and positioned so as to obtain at least one near-infrared (NIR) image of the ground surface over which the UAV is flown.

It should be appreciated that all combinations of the foregoing concepts and additional concepts discussed in greater detail below (provided such concepts are not mutually inconsistent) are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a perspective view of an illustrative unmanned aerial vehicle according to one embodiment of the present invention.

FIG. 2 is a side view of the unmanned aerial vehicle of FIG. 1.

FIG. 3 is a perspective view of a camera mount and camera holder according to one embodiment of the present invention.

FIG. 4 is a side view and perspective view of an illustrative camera mounted inside of a wing, according to one embodiment of the present invention.

FIG. 5 is an example analysis of an indoor plant that illustrates image processing techniques for estimating plant health based on acquired images, according to one embodiment of the present invention.

FIG. 6 is an example analysis of a grass lawn that further illustrates image processing techniques for estimating vegetation health based on acquired images, according to one embodiment of the present invention.

### DETAILED DESCRIPTION

Following below are more detailed descriptions of various concepts related to, and embodiments of, inventive systems, methods and apparatus for aerial assessment of ground surfaces. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

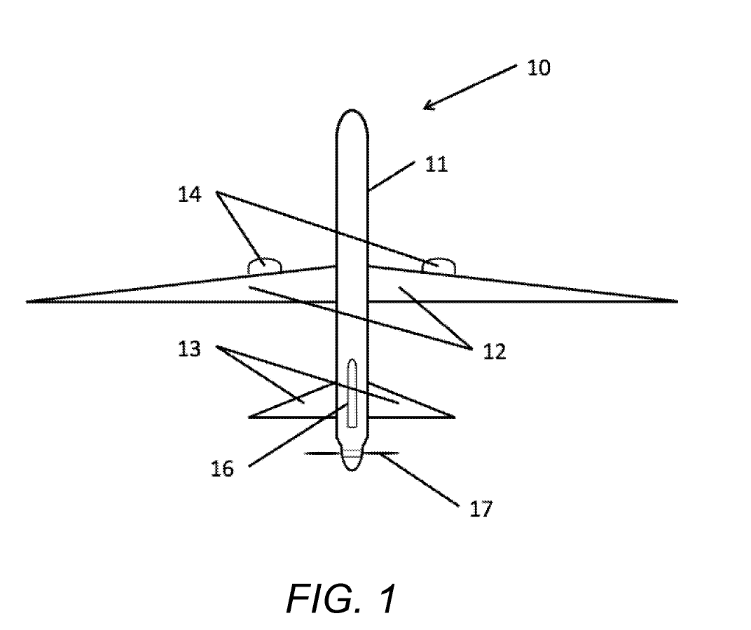

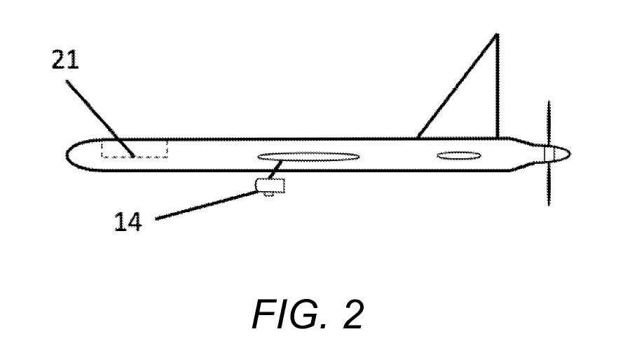

FIGS. 1 and 2 show an illustrative example of a UAV 10, according to one embodiment of the present invention. The vehicle comprises a main body of the fuselage 11. Wings 12 are attached to the fuselage and two cameras 14 are mounted on the wings. While two cameras 14 are illustrated in the figures, it should be appreciated that a different number and alternative arrangements of multiple cameras may be contemplated according to other embodiments. The use of multiple cameras on the airplane has particular advantages in some exemplary implementations, as discussed in greater detail below. Horizontal stabilizer 13 and vertical stabilizer 16 are also attached to the main body of the UAV. An electric motor is located inside the main body and is connected to a propeller 17. The electronics 21, such as the autopilot system (e.g., including a location tracking system such as a GPS receiver) and a custom-made circuit to synchronize cameras are generally located inside the body in the front of the UAV.

In various embodiments, the UAV 10 may be pre-programmed on the ground via a user interface device (e.g., a mobile device such as a cell-phone or a tablet, or a laptop/desktop computer), and then hand-launched. In one implementation, the user interface is configured to facilitate intuitive ease of use to facilitate effective programming of the UAV by a modestly trained operator to successfully operate it. More specifically, an operator may provide via the user interface various set-up parameters for a given flight run of the UAV. In one example, via the user interface the operator may indicate set-up parameters including a surface coverage area that the UAV needs to cover (e.g., by using the user interface to drawing a polygon or otherwise specifying metes and bounds of the desired coverage area on a displayed map), a landing location and, optionally, crop/plant type and safe cruising altitude. These set-up parameters may then be wirelessly transmitted to the UAV's autopilot system.

In response to the set-up parameters provided by an operator via the user interface, the autopilot system of the UAV plans a safe route to effectively survey the ground surface throughout the specified coverage area. More specifically, the autopilot system determines various flight parameters including, for example, an appropriate takeoff speed and angle, cruise altitude and speed, and landing speed and direction. The autopilot system calculates these flight parameters based on various attributes and limitations of the UAV (e.g., weight, power, turn angle, stall speed, etc.) and terrain features, such as slope of the ground surface within the coverage area, nearby mountains, buildings, and other man made objects.

The UAV 10 is propelled forward via an electric motor that is connected to a battery located in the main body 11. In the event that the UAV depletes its battery during a given flight run, the UAV automatically lands at a predetermined landing location. While not shown in the figures, to increase the flight time of the UAV lightweight solar panels may be installed on the wings to generate electricity to charge the batteries while the UAV is flying or waiting on the ground to be flown.

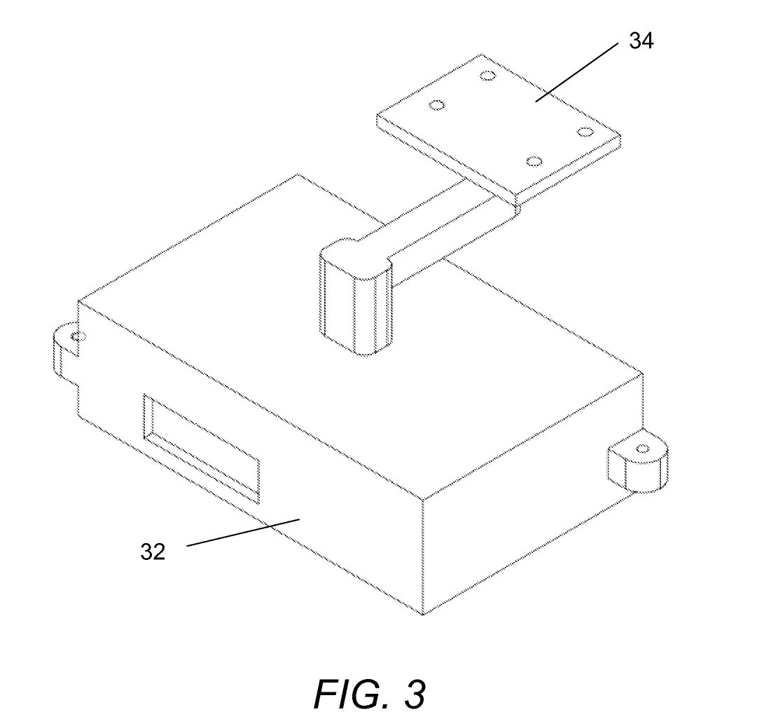

While in flight over the coverage area, the UAV automatically acquires images using the two cameras 14 that in the current configuration are mounted on the wings 12 to be closer to the center of gravity of the plane, as well as above ground when landing. The cameras may attached to the wings using the assembly of a camera holder 32 and a camera mount 34 shown in FIG. 3. In some implementations, the camera holder/camera mount assembly may be created using a 3D printer. In other implementations, to lower the manufacturing costs even further, methods such as injection molding and casting can be utilized to manufacture the holder and the mount, as well as other parts of the airplane. In yet other implementations, the camera holder and the camera mount have a modular design (e.g., they may be readily detached from one another and re-attached to each other), and or the camera holder may have a particular configuration, to facilitate ease of coupling and decoupling the cameras from the UAV (e.g., to facilitate using different makes/models of cameras, occasional camera repair, etc.).

In other inventive aspects, the camera holder shown in FIG. 3 may be stabilized either passively (i.e., using gravity to point the cameras downward) or actively (i.e., using an active mechanism such as servomotors to stabilize the cameras and reduce shakiness) to improve image quality and usefulness. When stabilizing cameras passively, the camera mounts may include gimbal mounts to ensure that gravity causes the cameras to be pointed substantially downward. When stabilizing cameras actively, information from an inertial measurement unit (e.g., included as part of the electronics 21 shown in FIG. 1), which includes accelerometers and gyroscopes, is used to detect changes in aircraft pitch, roll, and yaw and use this information to counterbalance the movement and shakiness of the UAV and point the cameras downward to the desired location on the ground using small servomotors.

The cameras are mounted close to the center of gravity of the plane, which means that the holders are located either inside/under the wings or inside/under the main body of the fuselage and still close to the wings. The camera mount and the camera holder are designed to be easily replaceable, i.e., camera holder can be easily detached and attached to the camera mount, which ensures that different types of cameras can be easily installed for various applications.

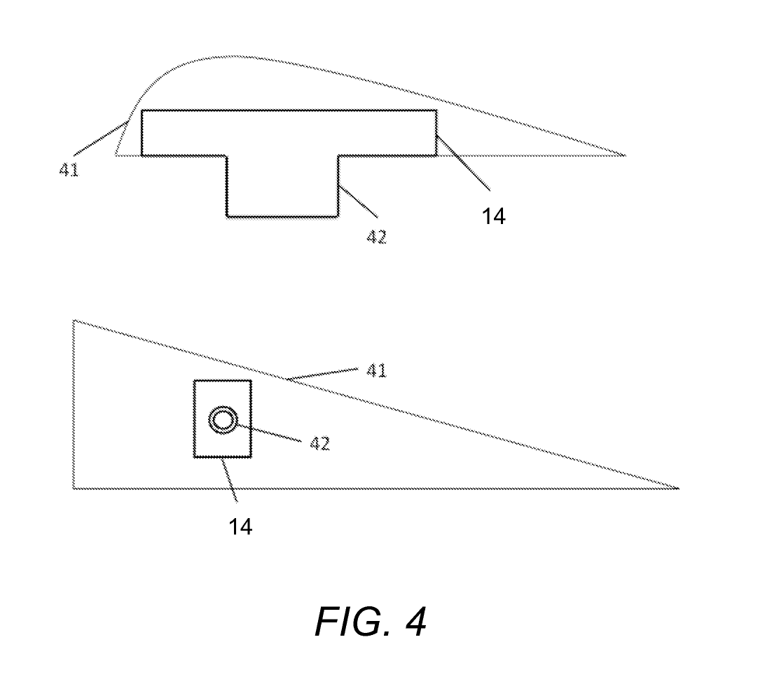

In another implementation, the cameras may be mounted inside the wings 41, as shown in FIG. 4, to create a more aerodynamic wing profile as well as facilitate increased protection of the camera 14. In the embodiment shown in FIG. 4, a lens 42 of the camera 14 is retracted during takeoff and landing to protect the lens from scratching.

Images captured by the cameras 14 may be stored on one or more memory cards in the UAV that are subsequently extracted from the UAV upon landing, so that the images stored on the cards may be recovered, processed and analyzed for particular features in the images relating to characterization of ground conditions. In some implementations, as an alternative or in addition to the memory card(s), information relating to acquired images may be wirelessly transmitted from the UAV to a remote device for processing and analysis. In one embodiment, one of the cameras takes a red, green, and blue (RGB) image (similar to that acquired by a conventional digital camera), while the other camera takes a near-infrared (NIR) image in the range of 800 nanometers to 1100 nanometers (e.g., an image in which incident radiation outside of the range of 800 nanometers to 1100 nanometers is substantially filtered out prior to the radiation impinging on the imaging plane of the camera, such as an imaging pixel array). Most commercial charge-coupled device (CCD) cameras are sensitive to a wide spectrum range typically from ultraviolet to NIR. In order to limit the sensitivity of the cameras to the visible spectrum for the general consumer, camera manufacturers install filters in the lens assembly in front of the CCS to significantly filter out radiation outside of the visible spectrum. Removing the manufacturer-installed visible filter and installing a NIR filter provides the ability to capture NIR images.

In some embodiments, conventional, and relatively lightweight and inexpensive, consumer-grade cameras may be employed as the cameras 14. For example, in one implementation two Canon A2200 cameras may be used for the cameras 14. Each camera has a 14.1 megapixels imaging sensor with 16 GB of memory. In some embodiments, the firmware in both cameras may be modified to capture images in raw format, retract camera lenses when needed, and trigger cameras remotely using a USB cable. One of the cameras captures images in the visible spectrum of electromagnetic radiation, while the other camera is modified to include a near infrared (NIR) high pass filter to capture electromagnetic wavelengths above 800 nanometers. More specifically, in the modified camera, the original low pass filter to enable acquisition of images using the visible spectrum (which generally blocks electromagnetic radiation having wavelengths greater than 700 nm) is removed. Due to the fact that the charge-coupled device (CCD) sensors in Canon A2200 cameras are not sensitive to wavelengths of light above approximately 1100 nm, with the installed NIR high pass filter the effective wavelength range that the camera captures is between 800 nm and 1100 nm. In one implementation, the NIR filter is placed in the modified camera behind the lens structure of the camera and before the CCD sensor. In cameras with specifications that are substantially different from Canon A200, it is also possible to install an external NIR filter on the lens of the camera.

In other embodiments, it is possible to install other high pass or band pass filters to capture only the desired wavelengths of electromagnetic radiation for a particular ground assessment application. Moreover, different CCD sensors generally have different light sensitivity parameters, which may also impact the selection of appropriate filters to facilitate image acquisition in regions of spectrum of particular interest for a given ground assessment application. For example, if an imaging sensor is sensitive to electromagnetic radiation below 3500 nanometers, then a high pass filter may not be enough to take images only in NIR spectrum and a band pass filter may be needed (since NIR spectrum does not include electromagnetic wavelengths greater than 2500 nanometers).

Furthermore, images may be taken at multiple different wavelengths to capture different attributes of plants and soil. For instance, middle infrared images may be used to estimate water content in the soil. Information about mineral spectra may also be collected and used to estimate the levels of common minerals such as calcite, kaolinite, and hematite, among others.

In general, images in different spectra can reveal specific information about one or more features of ground surfaces that images in only one spectrum (e.g., just the visible spectrum) cannot. For estimating crop health and density, different bandwidths of NIR spectrum may be used depending on the specificity of the application and lighting conditions. A modification of a consumer-grade camera from visible to NIR costs significantly less than specialized NIR cameras, which helps considerably lower the cost of assessing various characteristics of ground surfaces according to various embodiments of the present invention.

The two cameras 14 are synchronized using a timing circuit (e.g., which may form part of the electronics 21 shown in FIG. 1) to acquire images from the respective cameras at substantially the same time. The timing circuit ensures that the two cameras take images at the same time and frequently enough not to leave any gaps in the coverage area over which the UAV is flown. In one exemplary embodiment, the trigger signal is a 5V signal pulse that lasts approximately 500 milliseconds and repeats every 8 seconds to trigger the cameras to take images. In other embodiments, trigger frequency may be based on the speed of the UAV and its above ground altitude. Knowing the speed of the aircraft, its altitude and the size of the field of view of the cameras, the trigger frequency may be calculated to ensure that images are taken with sufficient frequency to cover a substantial portion if not effectively the entire coverage area of interest. The trigger circuit is powered by the UAV's battery and uses a timing chip (integrated circuit) to generate trigger pulses. An amplifier is then used to amplify the signal to 5V to be detected by the cameras. The frequency of the pulses may be controlled via the autopilot system by changing the timing parameters of the integrated chip. In other implementations, the circuit may be used to trigger more than two cameras, if for a specific application more than two cameras are used.

Once the UAV flies its pre-programmed path, it lands autonomously in an open area. In some implementations, the images captured by the cameras 14 are stored on one or more memory cards in the UAV that are subsequently extracted from the UAV upon landing, so that the images stored on the cards may be recovered, processed and analyzed for particular features in the images relating to characterization of ground conditions. In other implementations, images are transferred wirelessly (e.g., through cellular network) for further analysis.

In one exemplary implementation, the UAV 10 has a wingspan of about 3 ft. and ability to lift additional weight of approximately 500 grams. Also, as discussed above, in one exemplary implementation the cameras 14 may be conventional digital cameras, at least one of which is modified according to the inventive techniques described herein to acquire images in a near-infrared spectrum to facilitate some types of ground characterization. For implementations in which conventional cameras are employed with appropriate modifications pursuant to the inventive concepts herein, in combination the cameras may weigh less than 350 grams.

In one exemplary embodiment, the UAV 10 is manufactured from plastic foam and reinforced with carbon fiber. This ensures that the fuselage is lightweight, inexpensive, and robust against various environmental conditions so as to prolong its useful life. Moreover, the chosen material allows for easy repairs if the airplane is damaged during takeoff or landing. More specifically, gluing or taping damaged parts to the main body of the airplane can repair plastic foam. Other alternatives of constructing the fuselage include polyolefin, plastic, aluminum, wood, carbon fiber, among other options of lightweight and robust materials. In one exemplary embodiment, the camera mount is manufactured from acrylonitrile butadiene styrenein (ABS) thermoplastic. Other plastic materials can be used to replace ABS thermoplastic, as well as more common materials such as aluminum and carbon fiber can be used.

Once the raw images as acquired by the cameras are extracted from the cameras for processing (e.g., either from one or more memory cards, or via wireless transmission of image information), they may be processed to correct for atmospheric and lens distortion. Since the two cameras are mounted at some distance from each other, they do not have the same exact field of view. To account for this, each pair of images taken by the two cameras at the same time are compared and, if required, these images are cropped and rotated to substantially, and if possible precisely, match each other's field of view. Next, images are mosaicked and geo-referenced using the information collected from the UAV's autopilot system (e.g., which may include a location tracking system such as an onboard GPS receiver).

In some embodiments relating to agricultural diagnostics, the images acquired by and extracted from the cameras may be further processed to estimate relative crop health at very fine resolution. For example, crop health may be assessed based at least in part on the Normalized Difference Vegetation Index (NDVI), which estimates the degree of vegetative cover using the multispectral images (see “Analysis of the phenology of global vegetation using meteorological satellite data” by Justice, C., et al, which is hereby incorporated by reference herein). These images may also be used to compute the Transformed Chlorophyll Absorption in Reflectance Index (TCARI) and the Optimized Soil-Adjusted Vegetation Index (OSAVI). These two indices can be used to estimate chlorophyll concentration in the plants, which is directly correlated to plant health (see “Integrated narrow-band vegetation indices for prediction of crop chlorophyll content for application to precision agriculture” by Haboudane, D., et al, which is hereby incorporated by reference herein).

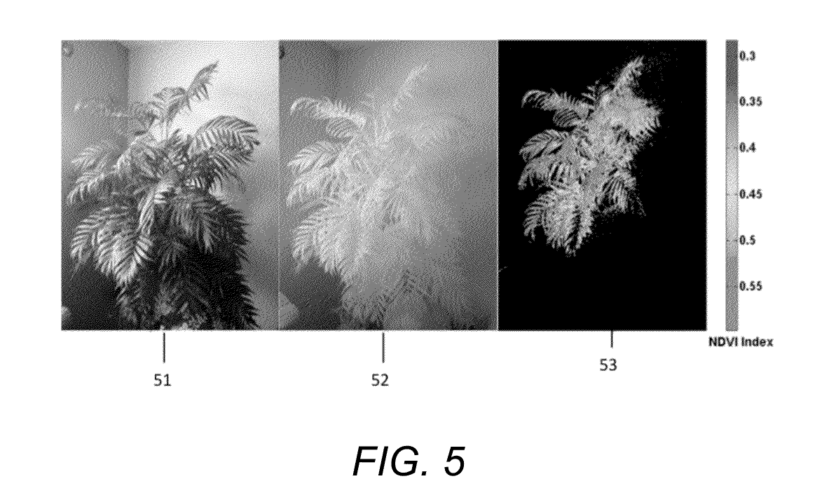

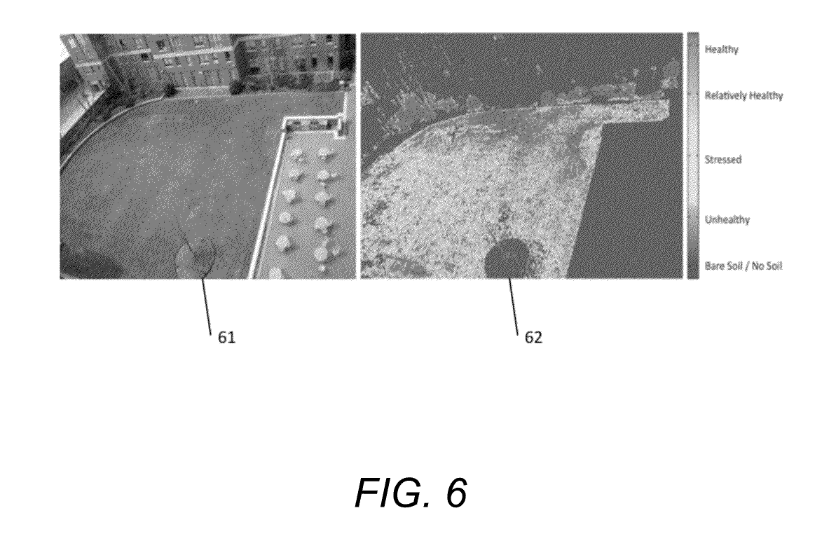

FIGS. 5 and 6 illustrate examples of comparative imagery that provides an intuitive visual illustration of crop health based on the various indexes discussed above. In the examples illustrated in FIGS. 5 and 6, each pixel in the visible image 51, 61 is compared to its corresponding pixel in the NIR image 52 to calculate the NDVI index. (Note that the NIR image corresponding to image 61 in FIG. 6 is not shown). A NDVI map 53, 63 is then created, which is color-coded to show healthy areas in green and unhealthy areas in red (it should be appreciated that other color coding schemes may be employed to show healthy and unhealthy areas).

In some implementations, the data from the NDVI map may be subsequently fed to a chemical prescription calculator software that determines types and amounts of chemicals that are recommended to improve health in areas indicated to be unhealthy. The type/amount of chemicals is created in a map format, which is color-coded and overlaid on top of the visible image of the crop field. The image analysis process is highly automated and provides an intuitive and easy interface for the farmer/operator to guide the actual chemical application process. In other implementations, the type and amount of chemicals, along with the geographic coordinates to apply the chemicals can be provided in an electronic form to use in advanced tractors or other machinery, when applying the chemicals. This further automates crop health estimation and chemical application processes.

Furthermore, since the UAV can be used economically and significantly more often than conventional aircrafts or satellites, it can be employed to survey the same general coverage area over various time periods (e.g., days, weeks, months) so as to iteratively generate assessments of ground conditions (e.g., plant health, soil conditions) in the coverage area as a time series of information regarding static or evolving conditions in the coverage area relating to plant life and/or soil. This time series of information may be used to make predictions about crop yield, healthiness, and required water/nutrient levels in the future, among other attributes.

The advantages provided by various embodiments of the present invention include, without limitation, ease of use, quality of information provided, and low price. More specifically, in some embodiments, the UAV and associated tools for flying the UAV are designed to be used by a person who may only be modestly trained in the use and functioning of the equipment. Additionally, cost advantages are provided, due at least in part to the innovative modification of conventional cameras and innovative design of the lightweight, small UAV using printable manufacturing methods. Other advantages include the design and integration of camera mounts to ensure high quality of acquired images, without image shakiness and ability to easily plug and unplug the cameras. Furthermore, the custom software for processing images is designed to allow minimally trained operator to quickly and effectively understand the results of the analysis.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, an intelligent network (IN) or the Internet. Such networks may be based on any suitable technology and may operate according to any suitable protocol and may include wireless networks, wired networks or fiber optic networks.

Any computer discussed herein may comprise a memory, one or more processing units (also referred to herein simply as “processors”), one or more communication interfaces, one or more display units, and one or more user input devices (user interfaces). The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Various embodiments described herein are to be understood in both open and closed terms. In particular, additional features that are not expressly recited for an embodiment may fall within the scope of a corresponding claim, or can be expressly disclaimed (e.g., excluded by negative claim language), depending on the specific language recited in a given claim.

Unless otherwise stated, any first range explicitly specified also may include or refer to one or more smaller inclusive second ranges, each second range having a variety of possible endpoints that fall within the first range. For example, if a first range of 3 dB<x<10 dB is specified, this also specifies, at least by inference, 4 dB<x<9 dB, 4.2 dB<x<8.7 dB, and the like.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

1. A hand-launched unmanned aerial vehicle (UAV) comprising:
a fuselage;
a first wing and a second wing respectively coupled to the fuselage;
a first camera coupled to the first wing to obtain at least one visible spectrum image of a ground surface over which the UAV is flown; and
a second camera coupled to the second wing to obtain at least one near-infrared (NIR) image of the ground surface over which the UAV is flown.

2. The UAV of claim 1, wherein a wingspan of the UAV is approximately three feet.

3. The UAV of claim 1, further comprising:
a battery disposed in the fuselage; and
an electric motor connected to the battery to propel the UAV,
wherein the UAV is configured to lift additional weight of approximately 500 grams.

4. The UAV of claim 3, wherein the first camera and the second camera, in combination, weigh less than 350 grams.

5. The UAV of claim 1, wherein the fuselage, the first wing, and the second wing include at least one manufacturing material selected from the group consisting of plastic, plastic foam, aluminum, and carbon fiber.

6. The UAV of claim 1, wherein:
the first camera is a conventional consumer grade digital camera including a first charge coupled device (CCD), a first lens assembly, and at least one first filter to significantly filter out radiation outside of the visible spectrum so as to obtain a red, green, and blue (RGB) image as the at least one visible spectrum image of the ground surface over which the UAV is flown; and
the second camera is a modified conventional consumer grade digital camera including a second CCD, a second lens assembly, and at least one NIR filter so as to obtain the at least one near-infrared image of the ground surface over which the UAV is flown.

7. The UAV of claim 6, wherein the second camera is configured such that the at least one near-infrared image obtained by the second camera is representative of radiation impinging on the second CCD in a range of approximately 800 nanometers to 1100 nanometers.

8. The UAV of claim 6, wherein a bandwidth of the spectrum of the at least one NIR filter is selected to facilitate estimation of crop health and density on the ground surface over which the UAV is flown.

9. The UAV of claim 1, further comprising a timing circuit, communicatively coupled to the first camera and the second camera, to trigger the first camera and the second camera to acquire the at least one visible spectrum image and the at least one near-infrared image at substantially the same time.

10. The UAV of claim 9, wherein in operation the timing circuit generates a trigger signal at a predefined frequency.

11. The UAV of claim 10, wherein the predefined frequency of the trigger signal is based on a ground speed and an altitude of the UAV.

12. The UAV of claim 10, wherein:
the first camera includes a first USB interface;
the second camera includes a second USB interface; and
the trigger circuit is coupled to the first USB interface and the second USB interface so as to provide the trigger signal to the first camera and the second camera.

13. The UAV of claim 1, further comprising an autopilot system, disposed inside the fuselage and programmable via a mobile device or a laptop/desktop computer, to automatically determine a speed, altitude, and flight pattern of the UAV based on a specification, via the mobile device or the laptop/desktop computer, of an area to be covered and a landing site for the UAV.

14. The UAV of claim 13, wherein the autopilot system comprises a GPS receiver to provide geo-referencing data for the at least one visible spectrum image and the at least one NIR image.

15. The UAV of claim 1, further comprising:
a first camera mount, coupled to the first wing, to facilitate mounting of the first camera to the first wing; and
a second camera mount, coupled to the second wing, to facilitate mounting of the second camera to the second wing,
wherein the first camera mount and the second camera mount are configured such that the first camera and the second camera are above the ground when the UAV is landing.

16. The UAV of claim 15, wherein the first camera mount and the second camera mount are 3D printed.

17. The UAV of claim 15, wherein the first camera mount and the second camera mount are injection molded and cast.

18. The UAV of claim 15, wherein:
the first camera mount includes a first gimbal mount coupled to the first wing; and
the second camera mount includes a second gimbal mount coupled to the second wing.

19. The UAV of claim 15, wherein:
the first camera mount includes a first servo motor coupled to the first wing; and
the second camera mount includes a second servo motor coupled to the second wing.

20. The UAV of claim 19, further comprising an inertial measurement unit, coupled to the first servo motor and the second servo motor, to detect changes in pitch, roll and yaw of the UAV and to control the first servo motor and the second servo motor based on the changes in pitch, roll and yaw.

21. The UAV of claim 15, further comprising:
a first camera holder detachably coupled to the first camera mount; and
a second camera holder detachably coupled to the second camera mount.

22. The UAV of claim 1, further comprising at least one memory card to store the at least one visible spectrum image and the at least one NIR image of the ground surface over which the UAV is flown.
